(19) United States
(12) Patent Application Publication
(10) Pub. No.: US 2004/0265463 A1
(43) Pub. Date: Dec. 30, 2004

(54) Processed cheese

(76) Inventor: Antonius Cornelius Maria Hendrickx, Veghel (NL)

Correspondence Address: Barbara E Johnson, 700 Koppers Building, 436 Seventh Avenue, Pittsburgh, PA, 15219-1818, US

(21) Appl. No.: 10/494,494

(22) PCT Filed: Nov. 7, 2001
(86) PCT No.: PCT/EP01/13087

(51) Int. Cl. A23C 19/00

(52) U.S. Cl. 426/582

(57) ABSTRACT

A processed cheese consisting of natural cheese and/or casein/caseinate, water, additives, optionally butter and/or butter fat, further comprising crosslinked caseinate as a structure-providing ingredient. Furthermore the invention comprises a method for preparing a processed cheese, by mixing natural cheese and/or casein/caseinate, water, additives, optionally butter and/or butter fat, while adding crosslinked caseinate as a structure-providing ingredient.

The present invention relates to processed cheese and to a method for making same.

Cheese is a concentrated dairy food made from milk. It is the fresh or matured product obtained by draining the whey (moisture or serum of original milk) after coagulation of casein, the major milk protein. Casein is coagulated by acid, which is produced through the addition of selected microorganisms and/or by coagulating enzymes, resulting in curd formation. Milk may also be acidified by adding foodgrade acidulants, which is the process (together with the addition of lactic cultures) often used in the manufacture of fresh cheese.

Natural cheese is a general classification for cheese that is made directly from milk. In fresh, unripened cheese, the curd, separated from the whey, can be used immediately, whereas in matured or ripened cheese, the curd is further treated by the addition of selected strains of bacteria, mold, yeast or a combination of these ripening agents. The bacteria, mold and yeast continue to ripen the cheese over time, changing the cheese's flavor and texture as it ages.

Natural cheese may be used as an ingredient for derived cheese products, so-called processed cheese. Related types are processed cheese spread (spreadable processed cheese) and sliceable processed cheese (or processed cheese food), which are made by blending one or more different kinds of natural cheese into a homogeneous mass. Through the addition of other optional ingredients such as salt and emulsifier, the appearance, texture and flavor of the cheese mass is modified. These cheeses are available in a variety of color intensities and flavors tailored to a variety of food processing applications.

Cheese analogs, or cheese substitutes (“imitation cheese”), are cheese-like products made without natural cheese. These products are prepared using caseinates, fat (vegetable fat or milk fat), water and melting salts. Suitable vegetable fats may be coconut fat or soy oil. As milk fat, butter can be used. These imitation cheeses are often less expensive than traditional natural cheese, but also have less flavor and poor melting performance.

Casein and caseinates are widely used in processed cheese and imitation cheese. Especially in those formulas, in which the concentration of intact casein protein from the natural cheese raw material is low or even absent, the emulsifying, structuring and stabilizing support of separately added (acid/rennet) casein(ate) is necessary. In spreadable processed cheese, some casein or caseinate can be added to increase, adjust and standardize the viscosity and spreadability of the final product.

An ongoing cost price issue within the processed cheese industry is the relative price comparison between natural cheese on the one hand and casein or caseinate in combination with butter or butterfat as a substitute on the other hand.

Casein and caseinates are widely used in processed cheese and imitation cheese. Especially in those formulas, in which the concentration of intact casein protein from the natural cheese raw material is low or even absent, the emulsifying, structuring and stabilizing support of separately added (acid/rennet) casein(ate) is necessary. In spreadable processed cheese some casein or caseinate can be added to increase, adjust and standardize the viscosity and spreadability of the final product. Although substitution of natural cheese by caseinate leads to acceptable fat stabilization due to the high emulsifying power of caseinate, the products structure, especially viscosity, does not always match the level of processed cheese made with all natural cheese.

It was then contemplated that a high viscous caseinate with an enhanced impact on structure or viscosity of processed cheese might be an interesting and economically attractive new casein source.

It was however found that high viscous types of caseinate like Hapro NHV™ (Lactalis, France), which is an aluminum containing caseinate and high viscous type EM10 (DMV International, The Netherlands) do not provide extra functionality in processed cheese compared to e.g. the commercial caseinate products, such as EM7 (DMV International, The Netherlands), that are usually used in processed cheese. Experiments showed that in processed cheese the high viscosity of these high viscous caseinates is completely “eliminated” due to the presence of significant amounts of emulsifying salts. High viscous caseinate as such is therefore not an alternative.

It is therefore the object of the present invention to provide a material for providing sufficient structure to the processed and imitation cheese that is cost effective while obtaining similar or better properties of the end product, such as viscosity, appearance after melting, consistency, organoleptic behavior etc. In particular it is the object of the invention to strengthen the function of casein as a support for the proteins present in natural cheese in adjusting the consistency of the processed cheese product.

This object of the invention could be obtained by using crosslinked caseinate as a structure-providing ingredient. The invention thus relates to processed cheese comprising natural cheese and/or casein/caseinate, water, additives, optionally butter and/or butterfat, wherein crosslinked caseinate is used as a structure-providing ingredient.

The crosslinked caseinate for use in the present invention can be any caseinate treated to be covalently crosslinked. Preferred crosslinked caseinate is obtainable by treating caseinate with an enzyme, preferably the enzyme transglutaminase. Transglutaminase catalyzes the formation of a-carboxyl-A-amino crosslinks in the casein molecule. The transglutaminase enzyme can be isolated from a microbial source, a fungus, a mold, a plant, a fish or a mammal. Preferred sources are microbes of the genus Streptoverticillium or the species Bacillus subtilis. Crosslinked caseinate can also be obtained from commercial suppliers. The crosslinked caseinate is preferably added in dry (powder) form. A specifically suitable source of crosslinked caseinate for use in this invention is as described in WO 01/70042 A1.

When the processed cheese of the invention is a spreadable processed cheese, it comprises natural cheese, casein/caseinate, water, additives, optionally butter and/or butter fat, wherein at least part of the casein/caseinate is replaced by crosslinked caseinate and optionally a source of dry matter is added, preferably dairy solids.

In case the processed cheese is a sliceable processed cheese, it comprises natural cheese, casein/caseinate, water, additives, optionally butter and/or butter fat, wherein at least part of the casein/caseinate is replaced by crosslinked caseinate and optionally a source of dry matter is added, preferably diary solids.

According to the invention it was found that crosslinked casein as (partial) replacement of conventional casein results in improved heat stability if processed cheese slices are re-heated. This is e.g. important for processed cheese slices in hot dishes (e.g. cheeseburgers).

The processed cheese can also be an imitation cheese, which comprises casein/caseinate, water, additives, and vegetable fat or milk fat, wherein at least part of the casein/caseinate is replaced by crosslinked caseinate and optionally a source of dry matter is added.

The additives that may be used in the processed cheese of the invention are the usual additives used in this field and are in particular selected from the group consisting of melting salts (phosphates and citrates), salts, food grade acids (lactic acid, citric acid), preserving agents (sorbate) and colorings.

According to the invention various natural cheeses may be used for example Gouda, Edammer, Cheddar, Emmenthaler, Tilsiter. The amount of natural cheese in the end product (spreadable and sliceable processed cheese) may vary from 20 to 90% w/w, preferably from 35 to 85% w/w, more preferably from 40 to 80% w/w depending on the end product. Spreadable cheese comprises less natural cheese than sliceable processed cheese. The skilled person in this field will know how to choose the amounts.

The casein/caseinate that is usually present in the processed cheese (spreadable and sliceable) composition in an amount between 1 and 10% w/w, preferably between 2 and 8% w/w and more preferably between 3 and 6% w/w , and for imitation cheese between 5 to 30% w/w, preferable between 10 to 30% w/w and more preferably between 20 to 30% w/w, is at least partially replaced by crosslinked caseinate. Partially in this respect means that a minimum of 10% w/w of the amount of casein/caseinate is replaced by crosslinked caseinate, preferably at least 25% w/w, more preferably at least 50% w/w and most preferable all of the conventional casein/caseinate is replaced.

It was found that when crosslinked caseinate is used, a lower amount is needed than when a conventional caseinate is used to obtain the same or even better properties. The source of dry matter is for compensating the loss in dry matter that is caused when using a lower amount of crosslinked caseinate than the amount of conventional caseinate commonly used. Sources of dry matter are for example skim milk powder (SMP) or cheese whey powder (ChWP).

Water is brought into the processed cheese as steam, which is injected during mixing and melting of the various ingredients and/or by separate addition. The total amount of water added depends on the type of processed cheese prepared.

Other optional ingredients are butter and/or butter fat. These are present when the fat originating from the natural cheese raw materials does not give enough creaminess to the product. They are preferably added in an amount of 3 to 40% w/w.

The present invention furthermore relates to a method for preparing a processed cheese, comprising mixing natural cheese and/or casein/caseinate, water, additives, optionally butter and/or butter fat, while replacing at least part of the casein/caseinate by crosslinked caseinate.

The present invention will be further illustrated in the examples that follow.

### EXAMPLES

### Example 1

Replacement of Conventional Casein by Crosslinked Casein in Spreadable Processed Cheese

1. Materials and Methods

The following two basic recipes were used for the tests:

Recipe A:

| | |
|---|---|
| 20 g | Melting salts* (2% w/w) |
| 207 g | Gouda cheese (20.7% w/w) |
| 241 g | Edammer cheese (24.1% w/w) |
| 50 g | Protein** (5% w/w) |
| 101 g | Butter (10.1% w/w) |
| 381 g | Water/vapor (38.1% w/w) |

*as melting salt a combination of two melting salts was
used namely a fifty-fifty blend of Self-H7 and Self H9
(Chemische Fabrik Budenheim, Germany)
**the composition of the protein ingredient is varied
according to Table 1

Recipe B:

| | |
|---|---|
| 20 g | Melting salts* (2% w/w) |
| 246 g | Gouda cheese (24.6% w/w) |
| 288 g | Edammer cheese (28.8% w/w) |
| 20 g | Protein*** (2% w/w) |
| 79 g | Butter (8% w/w) |
| 347 g | Water/vapor (34.7% w/w) |

*as melting salt a combination of two melting salts was
used namely a fifty-fifty blend of Self-H7 and Self-H9.
***in experiment B-1 2% w/w conventional caseinate (EM7)
was used; in B-2 2% w/w crosslinked caseinate.

The following requirements were chosen as a compositional starting point:

| | |
|---|---|
| Fat content in the product | 18% w/w minimum |
| Fat content on dry matter | 45% w/w minimum |
| Dry matter | 40% w/w minimum |

In recipe A the cheese/butter/water ratio is such that 5% w/w standard sodium caseinate has to be added to get the right consistency and the right chemical analyses. In recipe B more cheese and butter is used in such a way that only 2% w/w caseinate has to be used in order to meet the above-mentioned compositional requirements.

In recipe A the quantity of sodium caseinate (EM7, DMV International) was stepwise reduced and at the same time replaced with Skim Milk Powder (SMP) to keep the dry matter figures at the right level. The same was done with the crosslinked caseinate.

This gave the following testing scheme for recipe A.

TABLE 1

| | Sodium | Crosslinked | Skim milk |
|---|---|---|---|
| | caseinate | caseinate | powder |
| Test code | % w/w | % w/w | % w/w |
| A-1 | — | 5 | — |
| A-2 | — | 5 | — |
| A-3 | 5 | — | — |
| A-4 | — | 4 | 1 |
| A-5 | 4 | — | 1 |
| A-6 | — | 3 | 2 |
| A-7 | 3 | — | 2 |
| A-8 | — | 2 | 3 |
| A-9 | 2 | — | 3 |
| A-10 | — | 1 | 4 |
| A-11 | 1 | — | 4 |

The cheese raw materials were pre-ground and homogenized. All the ingredients were blended and melted in a small Kustner melting kettle with direct steam injection. After a total mixing/heating time of 6.5 minutes the mass reached a temperature of around 90° C. and after a final weight correction the melted cheese was filled in glass jars. After closing the jars with a twist-off lid they were turned upside down and cooled in the refrigerator.

After a few days storage at refrigerator temperature the samples were evaluated for spreadability, appearance and other organoleptic characteristics.

The viscosity/spreadability was also determined instrumentally with a Stable Micro Systems (SMS) TA-XT2 Texture Analyzer. The method is based on forcing the product to be tested in a crevice thus imitating the spreading of the product with a knife on toast or the like. The force (kg or N) necessary to displace the product and the amount of energy (kg s or N s) needed to achieve this are a measure for the spreadability of the product.

2. Experimental Results

The viscosity and appearance of the melted cheese at the end of the melting process gives a first indication of the functionality of the crosslinked caseinate compared to the conventional caseinate EM7. The batch with 5% w/w crosslinked caseinate clearly showed the highest viscosity. The cheese melts with either 3 or 4% w/w crosslinked caseinate showed viscosity's similar to the one with 5% w/w EM7, however they seemed to show more elasticity if stirred, which is considered indicative for a good texture.

The pH, dry matter analyses and spreadability measurement results are summarized in table 2.

TABLE 2

| Test | |
|---|---|
| code EM7 | |
| % w/w | Cross-linked caseinate |
| % w/w | Skim milk powder |
| % w/w | Dry Matter |
| % w/w | Max. force |

| Grams | | | | |
|---|---|---|---|---|
| A-1 | 5 | — | 37.15 | n.m.* |
| A-2 | 5 | — | 38.70 | n.m.* |
| A-3 | 5 | — | 37.10 | 4654 |
| A-4 | 4 | 1 | 37.40 | n.m.* |
| A-5 | 4 | 1 | 36.91 | 4073 |
| A-6 | 3 | 2 | 37.24 | 4939 |
| A-7 | 3 | 2 | 37.04 | 3448 |
| A-8 | 2 | 3 | 37.09 | 3766 |
| A-9 | 2 | 3 | 36.81 | 2657 |
| A-10 | 1 | 4 | 37.20 | 2067 |
| A-11 | 1 | 4 | 37.50 | 1899 |

*n.m. = not measurable i.e. too firm and outside range of load cell (these products in fact were that firm, that they could not be regarded as spreadable).

From table 2 it can be seen that the product with 3% w/w crosslinked caseinate (and 2% w/w SMP) has a somewhat higher viscosity than the reference product with 5% w/w EM7.

During the sensorial evaluation the same impression was experienced: from consistency point of view 5% w/w EM7 can be replaced with a blend of crosslinked casein and SMP with a mixing ratio between 40:60 and 60:40.

With higher levels of crosslinked caseinate the product gets a more gel like appearance. The product with relatively high levels of crosslinked caseinate (4 or 5% w/w) has a less shiny surface and a less smooth structure.

In recipe B the results were obtained indicated 15 in table 3.

TABLE 3

| | | Crosslinked | | | |
|---|---|---|---|---|---|
| Test | EM7 | caseinate | | Dry Matter | Max. force |
| code | % w/w | % w/w | pH | % w/w | Grams |
| B-1 | | 2 | 5.80 | 37.45 | 5112 |
| B-2 | 2 | | 5.70 | 37.85 | 3720 |

From this result can be concluded that at lower addition levels i.e. 2% w/w crosslinked caseinate brings a considerably higher viscosity than EM7 if exchanged on a 1:1 basis.

### Example 2

Test of Various Products

1. Spreadable Processed Cheese

The tests as described in Example 1 were repeated using a different ingredient to bring the dry matter content at the required level, i.e. cheese whey powder (ChWP) instead of skim milk powder (SMP).

The viscosity/spreadability of the various processed cheese samples were measured again with the SMS Texture Analyzer. The measuring results are presented in table 4.

TABLE 4

| | Cross-linked | | | |
|---|---|---|---|---|
| EM7 | caseinate | SMP | ChWP | Max. force |
| % w/w | % w/w | % w/w | % w/w | In grams |
| 5 | | | | 3042 |
| 5 | | | | 3026 |
| 5 | | | | 2664 |
| 5 | | | | 2983 |
| | 2 | 3 | | 1766 |
| | 2 | 3 | | 1936 |
| | 3 | 2 | | 2713 |
| | 3 | 2 | | 2821 |
| | 4 | 1 | | 4599 |
| | 4 | 1 | | 4627 |
| | 2 | | 3 | 891 |
| | 2 | | 3 | 790 |
| | 3 | | 2 | 2502 |
| | 3 | | 2 | 2528 |
| | 4 | | 1 | 3347 |
| | 4 | | 1 | 3720 |
| | 4 | | 1 | 3936 |

From the table and the spreadability measurements it can be concluded that around 3% w/w crosslinked caseinate toghether with either 2% w/w skim milk powder or cheese whey product gives about the same viscosity to the product.

Visual/organoleptic evaluation of the samples by four tasters leads to the unanimous conclusion, that the products with 2% w/w crosslinked caseinate (with 3% w/w SMP or ChWP) had a softer consistency than the reference product with 5% w/w EM7. The products with 3% w/w crosslinked caseinate however (with 2% w/w SMP or ChWP) resulted in products that were firmer. These spreadability measurements and organoleptic evaluations indicate that the dosage of EM7 can be reduced with 40 to 50% w/w (provided that the dry matter gap is filled with either SMP or ChWP).

2. Sliceable Processed Cheese (=Block Cheese)

In a basic recipe (Edam cheese 37.27% w/w, Gouda cheese 31.98% w/w, protein 5% w/w, butter 11.91% wlw, water 11.83% w/w and “SELF” melting salt 2% w/w) containing 5% w/w EM7 this quantity was replaced with 2, 3 or 4% w/w crosslinked caseinate, while keeping the dry matter at the same level by adding extra whey powder.

In the masses coming from the melting kettle there were no major differences. In the chilled final products the consistency differences are less apparent than in the spreadable processed cheese.

A melting test was done in which slices of 1 cm thick were sliced and from the slices a star form shape was punched out with a cookie mould. The star-shaped cheese samples were placed in an oven and after a standard heating time (150° C., 9 min) the cheese forms were chilled. Even with the lowest level of crosslinked caseinate (i.e. 2% w/w+3% w/w ChWP) the shape was maintained clearly better in the oven than with the reference product containing 5% w/w EM7.

3. Imitation Cheese Based on Sodium Caseinate

Crosslinked caseinate was tested as replacement of sodium caseinate in the following imitation cheese recipe:

| | |
|---|---|
| Sodium caseinate | 28.5% w/w |
| Butter | 25.1% w/w |
| NaCl | 1.0% w/w |
| Melting salts | 1.5% w/w |
| Water | 43.8% w/w |

Complete 1:1 replacement led to a very hard, elastic structure. Addition of 10% w/w extra water still gave a far too firm texture already in the emulsification apparatus.

Also in this kind of sodium caseinate based imitation cheeses crosslinked caseinate exhibits its extra functionality in terms of viscosity and consistency. A considerable reduction in caseinate dosage is possible if crosslinked caseinate is used instead of standard sodium caseinate.

1-16. (Cancelled).

17. Processed cheese comprising natural cheese and/or casein/caseinate, water, additives, crosslinked caseinate as a structure-providing ingredient and optionally butter and/or butter fat.

18. Processed cheese as claimed in claim 1, characterized in that the crosslinked caseinate is obtainable by treating caseinate with the enzyme transglutaminase.

19. Processed cheese as claimed in claim 18, which is a spreadable processed cheese comprising natural cheese, casein/caseinate, water, additives, optionally butter and/or butterfat, characterized in that it comprises crosslinked caseinate as a structure-providing ingredient and optionally a source of dry matter.

20. Processed cheese as claimed in claim 18, which is a sliceable processed cheese comprising natural cheese, casein/caseinate, water, additives, optionally butter and/or butter fat, characterized in that it comprises crosslinked caseinate as a structure-providing ingredient and optionally a source of dry matter.

21. Processed cheese as claimed in claim 18, which is an imitation cheese comprising casein/caseinate, water, additives, and vegetable fat, characterized in that it comprises crosslinked caseinate as a structure-providing ingredient and optionally a source of dry matter.

22. Processed cheese as claimed in claim 17, characterized in that the additives are selected from the group consisting of melting salts (phosphates and citrates), salts, food grade acids (lactic acid, citric acid), preserving agents (sorbate) and colorings.

23. Processed cheese as claimed in claim 17, wherein the natural cheese is selected from Gouda, Edammer, Cheddar, Emmenthaler, Tilsiter or combinations of two or more of these.

24. Processed cheese as claimed in claim 23, wherein the amount of natural cheese in the end product may vary from 0 to 90% w/w depending on the end product.

25. Processed cheese as claimed in claim 23, wherein the amount of natural cheese in the end product may vary from 30 to 90% w/w depending on the end product.

26. Processed cheese as claimed in claim 23, wherein the amount of natural cheese in the end product may vary from 35 to 85% w/w depending on the end product.

27. Processed cheese as claimed in claim 23, wherein the amount of natural cheese in the end product may vary from 40 to 80% w/w depending on the end product.

28. Processed cheese as claimed in claim 18, wherein the amount of crosslinked caseinate based on the total amount of casein/caseinate is at least 10% w/w.

29. Processed cheese as claimed in claim 18, wherein the amount of crosslinked caseinate based on the total amount of casein/caseinate is at least 25% w/w.

30. Processed cheese as claimed in claim 18, wherein the amount of crosslinked caseinate based on the total amount of casein/caseinate is at least 50% w/w.

31. Processed cheese as claimed in claim 18, wherein the amount of crosslinked caseinate based on the total amount of casein/caseinate is at least 100% w/w.

32. Processed cheese as claimed in claim 18, wherein the total amount of casein/caseinate, which is usually present in a processed cheese composition is an amount between 1 and 10% w/w when the end product is spreadable or sliceable cheese, and when the end product is imitation cheese the casein/caseinate is usually present in the processed cheese composition in an amount between 5 and 30% w/w, wherein the casein/caseinate is at least partially replaced by crosslinked caseinate, and wherein partially in this respect means that a minimum of 10% w/w of the amount of casein/caseinate is replaced by crosslinked caseinate.

33. Processed cheese as claimed in claim 18, wherein the total amount of casein/caseinate, which is usually present in a processed cheese composition, is an amount between 2 and 8% w/w when the end product is spreadable or sliceable cheese, and when the end product is imitation cheese the casein/caseinate is usually present in the processed cheese composition in an amount between 10 and 30% w/w, wherein the casein/caseinate is at least partially replaced by crosslinked caseinate, and wherein partially in this respect means that at least 25% w/w of the amount of casein/caseinate is replaced by crosslinked caseinate.

34. Processed cheese as claimed in claim 18, wherein the total amount of casein/caseinate, which is usually present in a processed cheese composition, is an amount between 3 and 6% w/w when the end product is spreadable or sliceable cheese, and when the end product is imitation cheese the casein/caseinate is usually present in the processed cheese composition in an amount between 20 and 30% w/w, wherein the casein/caseinate is at least partially replaced by crosslinked caseinate, and wherein partially in this respect means that at least 50% w/w of the amount of casein/caseinate is replaced by crosslinked caseinate.

35. Processed cheese as claimed in claim 34, wherein the total amount of casein/caseinate, which is usually present in a processed cheese composition, is an amount between 3 and 6% w/w when the end product is spreadable or sliceable cheese, and when the end product is imitation cheese the casein/caseinate is usually present in the processed cheese composition in an amount between 20 and 30% w/w, wherein the casein/caseinate is at least partially replaced by crosslinked caseinate, and wherein all of the conventional casein/caseinate is replaced by crosslinked caseinate.

36. Processed cheese as claimed in claim 17, wherein a source of dry matter is present.

37. Processed cheese as claimed in claim 36, wherein the source of dry matter is selected from the group consisting of skim milk powder (SMP), cheese whey powder (ChWP), lactose, permeate powder and combinations of two or more of these.

38. Spreadable processed cheese, comprising: natural cheese between 30 and 80% w/w, melting salts between 0.5 and 3.5% w/w, water between 10 and 60% w/w, caseinate between 1 and 6% w/w, butter between 3 and 20% w/w, and cheese whey powder between 0 and 10% w/w.

39. Spreadable processed cheese, comprising: natural cheese between 35 and 70% w/w, melting salts between 1.0 and 3.0% w/w, water between 20 and 50% w/w, caseinate between 2 and 6% w/w, butter between 5 and 15%, and cheese whey powder between 1 and 7% w/w.

40. Spreadable processed cheese, comprising: natural cheese between 40 and 55% w/w, melting salts between 1.5 and 2.5% w/w, water between 30 and 40% w/w, caseinate between 3 and 6% w/w, butter between 8 and 12%, and cheese whey powder between 2 and 5% w/w.

41. Sliceable processed cheese, comprising: natural cheese between 50 and 90% w/w, melting salts between 0.5 and 3.5% w/w, water between 5 and 25% w/w, caseinate between 1 and 10% w/w, and butter between 3 and 17% w/w.

42. Sliceable processed cheese, comprising: natural cheese between 60 and 85% w/w, melting salts between 1.0 and 3.0% w/w, water between 7 and 20% w/w, caseinate between 2 and 8% w/w, and butter between 7 and 15% w/w.

43. Sliceable processed cheese, comprising: natural cheese between 70 and 80% w/w, melting salts between 1.5 and 2.5% w/w, water between 10 and 15% w/w, caseinate between 3 and 6% w/w, and butter between 10 and 13% w/w.

44. Imitation cheese, comprising: melting salts between 0.3 and 3.5% w/w, water between 35 and 65% w/w, NaCl between 0.5 and 3.0% w/w, caseinate between 5 and 30% w/w, and vegetable fat or butter between 10 and 40% w/w.

45. Imitation cheese, comprising: melting salts between 0.5 and 3.0% w/w, water between 35 and 60% w/w, NaCl between 0.7 and 2.0% w/w, caseinate between 10 and 30% w/w, and vegetable fat or butter between 15 and 35% w/w.

46. Imitation cheese, comprising: melting salts between 0.7 and 1.5% w/w, water between 40 and 50% w/w, NaCl between 0.8 and 1.5% w/w, caseinate between 20 and 30% w/w, and vegetable fat or butter between 20 and 30% w/w.

47. Method for preparing a processed cheese, comprising: mixing natural cheese and/or casein/caseinate, water, additives, and optionally butter and/or butter fat, while adding crosslinked caseinate as a structure-providing ingredient.
